(19) United States
(12) Patent Application Publication
(10) Pub. No.: US 2026/0010896 A1
(43) Pub. Date: Jan. 8, 2026

(54) SYSTEMS AND METHODS FOR PROCESSING CRYPTOCURRENCY TRANSACTIONS

(71) Applicant: Visa International Service Association, San Francisco, CA (US)

(72) Inventors: Sananda Banerjee, San Jose, CA (US); Peter Cooling, Raleigh, NC (US); Eduardo Lopez, Menlo Park, CA (US); Cuy Sheffield, Menlo Park, CA (US)

(73) Assignee: Visa International Service Association, San Francisco, CA (US)

(21) Appl. No.: 19/128,535

(22) PCT Filed: Nov. 17, 2023
(86) PCT No.: PCT/US2023/080286

§ 371 Date: May 8, 2025

Related U.S. Application Data
(60) Provisional application No. 63/426,590, filed on Nov. 18, 2022.
(60) Provisional application No. 63/476,330, filed on Dec. 20, 2022.

(51) Int. Cl. G06Q 20/36; G06Q 20/38

(52) U.S. Cl. CPC G06Q 20/3674; G06Q 20/382; G06Q 2220/00

(57) ABSTRACT

Embodiments of the invention are directed to systems and methods for conducting a transaction using a cryptocurrency. A server computer may receive a transaction request for a cryptocurrency transaction from a user associated a resource provider. The server computer may provide the transaction details to a user device for confirmation. Upon receiving confirmation from the user device, the server computer can provide an authorization message to the resource provider computer indicating authorization of the cryptocurrency transaction. The server computer may receive an acceptance message from the resource provider computer. The server computer can provide, to the cryptocurrency exchange computer, the acceptance message, such that a transfer of cryptocurrency funds in the transaction amount from the funding source to an account of the resource provider associated with the resource provider computer.

### CROSS-REFERENCE TO RELATED APPLICATIONS

This application is a PCT application which claims the benefit of priority from U.S. Provisional Application No. 63/426,590, filed Nov. 18, 2022, titled “CRYPTOCURRENCY PROCESSING SYSTEM AND METHOD,” and U.S. Provisional Application No. 63/476,330, filed Dec. 20, 2022, titled “CRYPTOCURRENCY PROCESSING SYSTEM AND METHOD” which are incorporated by reference in their entireties for all purposes.

### BACKGROUND

A transaction to transfer cryptocurrency between two parties may use a cryptocurrency network of computers that jointly manage an electronic ledger of transactions. The process for confirming the transaction within the cryptocurrency network may take a substantial time to complete. Accordingly, it is impractical to use a cryptocurrency network to perform transactions that require confirmation in a relatively short period of time, such as e-commerce transactions. Thus, conventional systems may be improved with respect to latency and accessibility.

Embodiments of the present application address these and other problems individually and collectively.

### SUMMARY

One embodiment of the invention is directed to a method. The method comprising receiving, by a server computer, a transaction request for a cryptocurrency transaction from a user associated with a user device to a resource provider associated with a resource provider computer. The transaction request may include an indication of a cryptocurrency wallet associated with the user and a transaction amount, wherein the cryptocurrency wallet comprises a funding source. The method can further comprise communicating, by the server computer, with a cryptocurrency exchange computer associated with the cryptocurrency wallet to determine that a balance of the funding source is greater than or equal to the transaction amount. The method can further comprise providing, by the server computer to the user device, transaction details including the funding source, the transaction amount, and the balance of the funding source in the cryptocurrency wallet. The method can further comprise receiving, by the server computer, confirmation of the cryptocurrency transaction from the user device. The method can further comprise transmitting, by the server computer, an instruction to the cryptocurrency exchange computer to place a hold on the funding source for the transaction amount. The method can further comprise providing, by the server computer, an authorization message to the resource provider computer indicating authorization of the cryptocurrency transaction. The method can further comprise receiving, by the server computer from the resource provider computer, an acceptance message. The method can further comprise providing, by the server computer to the cryptocurrency exchange computer, the acceptance message, wherein a transfer of cryptocurrency funds in the transaction amount from the funding source to an account of the resource provider associated with the resource provider computer thereafter occurs.

Another embodiment of the invention is directed to an authorizing entity computer comprising a processor and a computer readable medium. The computer readable medium comprising code, executable by the processor, for implementing the above-described method.

Another embodiment of the invention is directed to a method. The method comprising receiving, by a server computer, a predetermined amount of funds from a cryptocurrency exchange computer. The predetermined amount of funds can be stored in an exchange sub-wallet of the server computer that is associated with the cryptocurrency exchange computer. The method can further comprise receiving, by a server computer, transaction information associated with a transaction between a user and a resource provider. The transaction can include a transaction amount and is associated with a cryptocurrency exchange computer. The method can further include, at a first predetermined interval, transferring, by the server computer, funds in the transaction amount from the exchange sub-wallet to a settlement wallet module.

Further details regarding embodiments can be found in the Detailed Description and the Figures.

### BRIEF DESCRIPTION OF THE DRAWINGS

FIG. 1 shows a block diagram of a system for performing a transaction using cryptocurrency.

FIG. 2 shows a block diagram of an exemplary server computer according to an embodiment of the invention.

FIG. 3 shows a block diagram of an exemplary user device computer according to an embodiment of the invention.

FIG. 4 shows a block diagram of an exemplary resource provider computer according to an embodiment of the invention.

FIG. 5 shows a block diagram of an exemplary gateway computer according to an embodiment of the invention.

FIG. 6 shows a block diagram of an exemplary cryptocurrency exchange computer according to an embodiment of the invention.

FIG. 7 shows a block diagram of an exemplary settlement wallet module according to an embodiment of the invention.

FIG. 8 shows a flow diagram illustrating a process for linking a cryptocurrency wallet to the server computer according to an embodiment of the invention.

FIGS. 9A and 9B show a flow diagram illustrating a process for performing a cryptocurrency transaction according to an embodiment of the invention.

FIG. 10 shows a flow diagram illustrating a process for performing a refund of a cryptocurrency transaction according to an embodiment of the invention.

FIGS. 11A and 11B illustrate exemplary graphical user interfaces (GUIs) displayed by a user device while performing a transaction using cryptocurrency according to an embodiment of the invention.

### DETAILED DESCRIPTION

Embodiments include systems and methods for enabling a user to complete a cryptocurrency transaction with a resource provider. For example, disclosed embodiments provide a payment network configured to enable users to link and aggregate their cryptocurrency wallets and to use cryptocurrency funds in those wallets to pay for goods and services. Currently, users may have one or more wallets storing different types of cryptocurrency, e.g., Bitcoin, Etherium, USD Coin, etc. When completing a transaction with a resource provider, the user cannot currently select one of their cryptocurrency wallets as a payment method or view their wallet balances during a checkout process with the resource provider. Further, transactions involving cryptocurrency experience inefficiencies and latency due to the time required for transactions to clear and settle. Thus, it is difficult and time consuming to attempt to complete an online transaction as part of a check out process.

Accordingly, disclosed embodiments overcome inefficiencies and hurdles in completing cryptocurrency transactions by providing a platform that enables the user to select a cryptocurrency wallet for payment and to complete payment with the resource provider in the selected cryptocurrency. The platform further enables resource providers to accept cryptocurrency as payment for goods and services, and handles the settlement of the cryptocurrency transactions in conjunctions with the appropriate cryptocurrency exchange. Further, disclosed embodiments enable charge backs and refunds to be completed in the original form of payment.

Further, disclosed embodiments provider increased protection for both the user and the resource provider in a cryptocurrency transaction. For example, the cryptocurrency payment platform enables resource providers to implement a know-your-customer (KYC) framework, where transactions are linked to a verified user. Thus, unknown entities cannot use the platform to perform nefarious or fraudulent cryptocurrency transfers. Further, the platform enables transaction protection for both the user and the resource provider by implementing balance checks through the payment/refund process to insure that sufficient funds to complete the transaction are available from either the user or the resource provider.

Disclosed embodiments facilitate transactions between a user and resource provider using stablecoins. A stablecoin, for example, can refer to a non-volatile cryptocurrency whose value is pegged to another asset class. For example, the value of a stablecoin can be pegged to a fiat currency, such as the U.S. dollar. An example of a stablecoin is USD Coin, which is pegged to the U.S. dollar. In other embodiments, disclosed systems and methods can enable transactions using Bitcoin or altcoins which are not tied to another asset class. Examples of altcoins include Ethereum and RSK.

For example, a user can interact with a platform to create an account on the platform for linking their cryptocurrency wallets and enabling payment from the linked cryptocurrency wallets. Similarly, a resource provider can communicate with the platform through one or more application programming interfaces (APIs) to accept cryptocurrency transactions from users. The platform facilitates exchange and settlement of the cryptocurrency transaction on a cryptocurrency exchange.

The platform can include a settlement wallet that is configured to handle cryptocurrency transactions, as well as cryptocurrency exchange sub-wallets from which the settlement wallet can be funded. For example, an exchange can fund a cryptocurrency settlement sub-wallet managed by the platform. Prior to authorizing a transaction between a user and a resource provider, the platform can confirm that the exchange sub-wallet and the user's wallet with the exchange are sufficiently funded to perform the transaction. Thus, the transaction can be approved and the checkout process can continue without a delay dependent on when and how long it will take for the transaction to settle. When the transaction is settled, funds are drawn down from the user's wallet and transferred to a wallet of the cryptocurrency exchange that is associated with the platform, and funds are transferred from the settlement wallet to a resource provider wallet associated with the resource provider. This process both insures and facilitates the transaction. Further, in some embodiments, the cryptocurrency exchange can put a soft hold on funds on the transaction amount in the user's cryptocurrency wallet.

In an example of disclosed embodiments, a server computer (e.g., a server computer hosting a platform) can receive a transaction request for a cryptocurrency transaction from a user to a resource provider. For example, the transaction request can be generated as a result of the user executing, via a user device, a checkout process with a resource provider via an application of the resource provider, a web browser, or a third-party payment service provider. The transaction request can include transaction information such as a selection of the cryptocurrency wallet to be used for payment and a transaction amount. In some examples, the cryptocurrency wallet can include one or more funding sources, e.g., the cryptocurrency wallet can hold multiple types of cryptocurrency at varying balances.

In some embodiments, the server computer can authenticate the user by prompting the user, via the user device, to provide and email address or phone number. The server computer can determine whether an account is associated with the provided information and send a one-time password (OTP) to the provided email address or phone number. The user then provides, via the user device, the OTP for verification by the server computer.

Upon authentication of the user, the server computer can communicate with a cryptocurrency exchange associated with the cryptocurrency wallet to determine whether a balance of the funding source is greater than or equal to the transaction amount, i.e., the server computer confirms the user has enough cryptocurrency in the selected cryptocurrency wallet to complete the requested transaction. In some embodiments, the server computer can also confirm that the cryptocurrency exchange sub-wallet has funds greater than or equal to the transaction amount.

The server computer can transmit the transaction details (e.g., the resource provider with which the transaction is occurring, the transaction amount, and the selected cryptocurrency wallet/funding source) to the user device to display to the user. The user can either approve or deny the transaction. If the user approves the transaction, the server computer receives an indication of the approval and can transmit the transaction details to a cryptocurrency exchange. In some embodiments the cryptocurrency exchange can put a hold or soft block on funds in the user's wallet in the transaction amount.

The cryptocurrency exchange can authorize the transaction and transmit the authorization status to the server computer. In turn, the server computer can forward the transaction status to a resource provider computer and/or the user device. In response, the resource provider computer can accept the transaction and communicate the acceptance to the server computer, which then communicates with the exchange to finalize fund withdrawal from the user wallet.

Finally, the server computer records the transaction for settlement. In some embodiments, settlement occurs at a predetermined epoch. Accordingly, when the transaction is settled, the blockchain associated with the cryptocurrency will record the sub-transactions necessary to transfer the transaction amount from the user to the resource provider. For example, the sub-transactions can be the transfer of funds from the user's wallet to the exchange's settlement wallet, from the exchange's settlement wallet to the server computer settlement wallet, and from the server computer settlement wallet to the resource provider wallet.

Systems and methods described herein facilitate seamless and efficient cryptocurrency transactions between users and resource providers. Unlike traditional methods of transferring cryptocurrency, which suffer from delays due to clearing and settlement, disclosed embodiments enable a user and resource provider to securely complete a transaction prior to settlement of the underlying cryptocurrency transaction.

A “user” may include an individual. In some examples, a user may be associated with one or more personal accounts, cryptocurrency wallets, and/or user devices. The user may also be referred to as a cardholder, account holder, or consumer in some embodiments.

A “user device” (sometimes referred to as a mobile communication device or a mobile device) may include any suitable electronic device that may be transported and operated by a user, which may also provide remote communication capabilities to a network. A user device may communicate using a mobile phone (wireless) network, wireless data network (e.g., 3G, 4G, 5G or similar networks), Wi-Fi, Bluetooth, Bluetooth Low Energy (BLE), Wi-Max, or any other communication medium that may provide access to a network such as the Internet or a private network. Examples of user devices include mobile phones (e.g., cellular phones), PDAs, tablet computers, net books, laptop computers, wearable devices (e.g., watches, rings, glasses), vehicles such as automobiles and motorcycles, personal music players, hand-held specialized readers, etc. A user device may include any suitable hardware and software for performing such functions, and may also include multiple devices or components (e.g., when a device has remote access to a network by tethering to another device—i.e., using the other device as a modem—both devices taken together may be considered a single user device).

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes, and other login information, etc. In some examples, a credential can be a one-time password (OTP) provided to the user via an email address or phone number.

A “digital wallet” may include an electronic device or service that allows an individual to conduct electronic commerce transactions. A digital wallet may store user profile information, credentials, bank account information, one or more digital wallet identifiers and/or the like and can be used in a variety of transactions, such as, but not limited to, eCommerce transactions, social network transactions, money transfer/personal payment transactions, mobile commerce transactions, proximity payment transactions, gaming transactions, etc. A digital wallet may be designed to streamline the purchase and payment process. Digital wallets may be used manage cryptocurrencies and execute cryptocurrency transactions, including, for example, receiving cryptocurrencies at a cryptocurrency address associated with the digital wallet holder or transmitting cryptocurrencies to other cryptocurrency addresses. In some embodiments, a digital wallet can store one or more blockchain addresses corresponding to blockchain accounts that are associated with the user and maintained in a publicly accessible ledger (e.g., a blockchain).

A “digital wallet provider” may include an entity, such as an issuing bank, which issues a digital wallet to a user that enables the user to conduct financial transactions. A digital wallet provider may provide standalone user-facing software applications that store account numbers on behalf of a cardholder (or other user) to facilitate payments at more than one unrelated merchant, perform person-to-person payments, or load financial value into the digital wallet. A digital wallet provider may enable a user to access its account via a personal computer, user device, or access device. Additionally, a digital wallet provider may also provide one or more of the following functions: storing one or more payment cards, maintaining one or more cryptocurrency accounts, storing other information including billing address, shipping addresses, and transaction history, initiating a transaction by one or more methods, such as providing a username and password, NFC, or a physical token, and may facilitate pass-through or two-step transactions.

A “cryptocurrency transaction” may include a transaction that utilizes cryptocurrency instead of fiat currency. Cryptocurrency transactions may include (but are not limited to) transactions using Bitcoin, Ethereum, and USDC. Cryptocurrency transactions may further be processed by a blockchain network or a cryptocurrency exchange. Responsive to processing, cryptocurrency transactions may be added to a ledger of transactions included within the blockchain network.

A “cryptocurrency exchange” may be an entity that facilitates exchanges of cryptocurrency currency between parties. The cryptocurrency exchange may manage any suitable number of accounts associated with registered parties. Users that wish to sell cryptocurrency may conduct a cryptocurrency transaction to transfer their cryptocurrency to the exchange and the exchange may manage the cryptocurrency on behalf of the user. Users may additionally, or alternatively, transfer fiat currency to the exchange and the exchange may manage the users' fiat currency within the exchange.

A “cryptocurrency network” may include a one or more computers that participate in maintaining a cryptocurrency ledger. In some cryptocurrency networks, the distributed cryptocurrency ledger may comprise a blockchain. A “blockchain” is a decentralized and distributed digital ledger that is used to record transactions across many computers so that the record cannot be altered retroactively without the alteration of all subsequent blocks and the collusion of the network. Examples of a cryptocurrency network may include networks of computers that manage any suitable cryptocurrency including, but not limited to, Bitcoin, Litecoin, Ethereum, Zcash, Dash, Ripple, and Monero.

A “resource provider” may be an entity that can provide a resource such as goods, services, information, and/or access. Examples of resource providers include merchants, data providers, transit agencies, governmental entities, venue and dwelling operators, etc. A “merchant” may typically be an entity that engages in transactions and can sell goods or services, or provide access to goods or services.

A “server computer” may include a powerful computer or cluster of computers associated with a payment processor or other financial entity. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers.

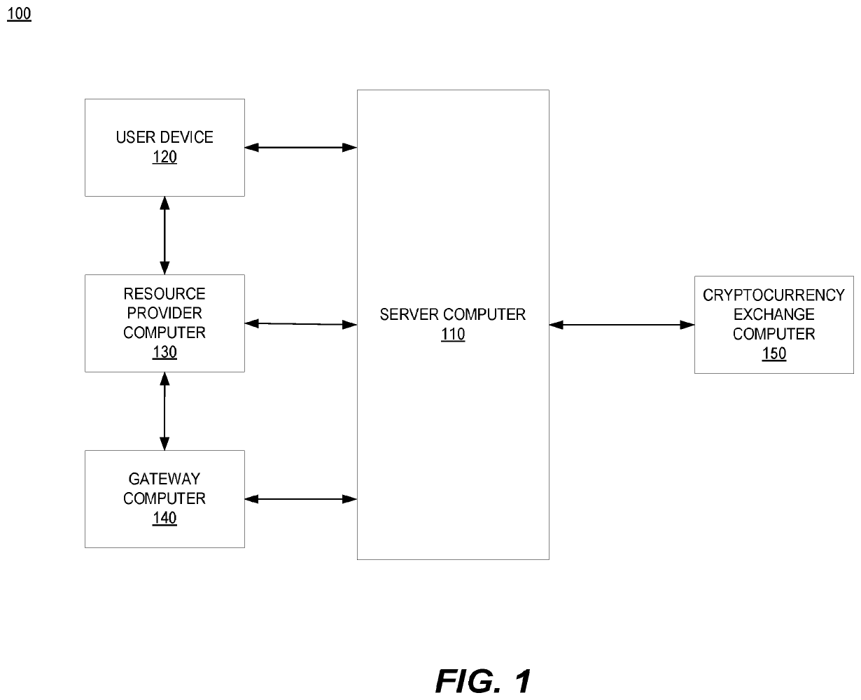

FIG. 1 shows a system 100 comprising a number of components. The system 100 includes a server computer 110, a user device 120, a resource provider computer 130, a gateway computer 140, and a cryptocurrency exchange computer 150, each of which may be embodied by one or more computers. One or more components of the system 100 can be used conduct a cryptocurrency transaction between a user and a resource provider according to disclosed embodiments.

For example, the system 100 can include a server computer 110, such as a cryptocurrency management network computer, that can serve as an intermediary between cryptocurrency exchange computer 150 (e.g., a consumer wallet aggregator) and a gateway computer 140 (e.g., a payment service provider or a merchant wallet aggregator), routing transactions and orchestrating money movement between source and destination wallets. The system 100 can be responsible for enabling exchanges to authenticate consumers, authorizing transactions, and settling transactions with the payment service providers on chain.

The user device 120, server computer 110, resource provider computer 130, gateway computer 140, and cryptocurrency exchange 150 may all be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

Messages between the computers, networks, servers, and devices may be transmitted using a secure communications protocols such as, but not limited to, Secure File Transfer Protocol (SFTP); Secure Hypertext Transfer Protocol (HTTPS), Secure Socket Layer (SSL), ISO (e.g., ISO 8583) and/or the like.

The server computer 110 may be associated with a payment processor, which may be an entity that enables payment processing between a resource provider and a user (e.g., a user associated with the user device 120). The server computer 110 can communicate with the user device 120, the resource provider computer 130, the gateway computer 140, and the cryptocurrency exchange 150, for example, to complete a cryptocurrency transaction between the user and the resource provider.

The user device 120 may be a device such as a smart phone, smart watch, wearable device, etc. capable of executing one or more applications stored thereon. The user device 120 may be capable of interacting with the server computer 110 and the resource provider computer 130. The user device 120 can, for example, access a website hosted by the resource provider computer 130 or the gateway computer 140, or access an application stored on the user device 120 and provided by the resource provider computer 130 or the gateway computer 140. The user device 120 can interact with the resource provider computer 130 and/or the gateway computer 140 to initiate a cryptocurrency transaction. For example, the cryptocurrency transaction can be initiated as part of a check out process in which the user wishes to exchange cryptocurrency for goods or services of the resource provider.

The resource provider computer 130 can be a computer or network of computers associated with a resource provider. The resource provider computer 130 can host an e-commerce website associated with the resource provider or can provide, to the user device 120, an application for facilitating interactions between the user and the resource provider. The resource provider computer 130 can also interact with the cryptocurrency exchange computer 150 directly or indirectly by communicating with the gateway computer 140. For example, the resource provider may have an associated cryptocurrency wallet configured to accept payment or issue refunds. In some examples, the resource provider cryptocurrency wallet can be provided or managed by the gateway computer 140.

The gateway computer 140 can be a computer or network of computers configured to facilitate transactions between users and resource providers. For example, the gateway computer 140 can be associated with a payment service provider. The gateway computer 140 can store and/or manage cryptocurrency wallets associated with one or more resource providers. The gateway computer 140 can interact with the server computer 110 and the resource provider computer 130 to facilitate cryptocurrency transactions.

The cryptocurrency exchange computer 150 can be a computer or network of computers that can facilitate exchange of cryptocurrency between parties. For example, the cryptocurrency exchange computer 150 can receive transaction details and periodically settle the transactions between the parties. Thus, the cryptocurrency exchange computer 150 can facilitate the transfer of cryptocurrency between the user device 120, the server computer 110, and the resource provider computer 130 and the respective cryptocurrency wallets associated therewith.

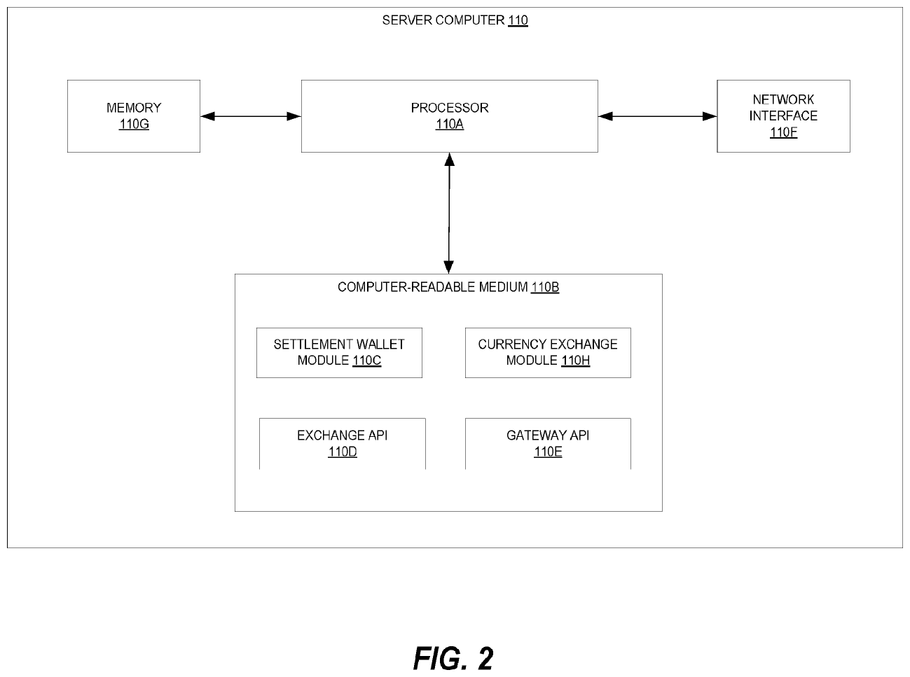

An example of the server computer 110 is shown in FIG. 2. In some embodiments, the server computer 110 can include components configured to execute the functionality described herein. For example, the server computer 110 can include a processor 110A, a computer-readable medium 110B, a network interface 110F, and a memory 110G.

The computer readable medium 110B may include code, executable by the processor 110A for implementing the methods discussed herein. For example, the computer-readable medium 110B can store a settlement wallet module 110C, an exchange application programming interface (API) 110D, a gateway API 110E, and a currency exchange module 110H.

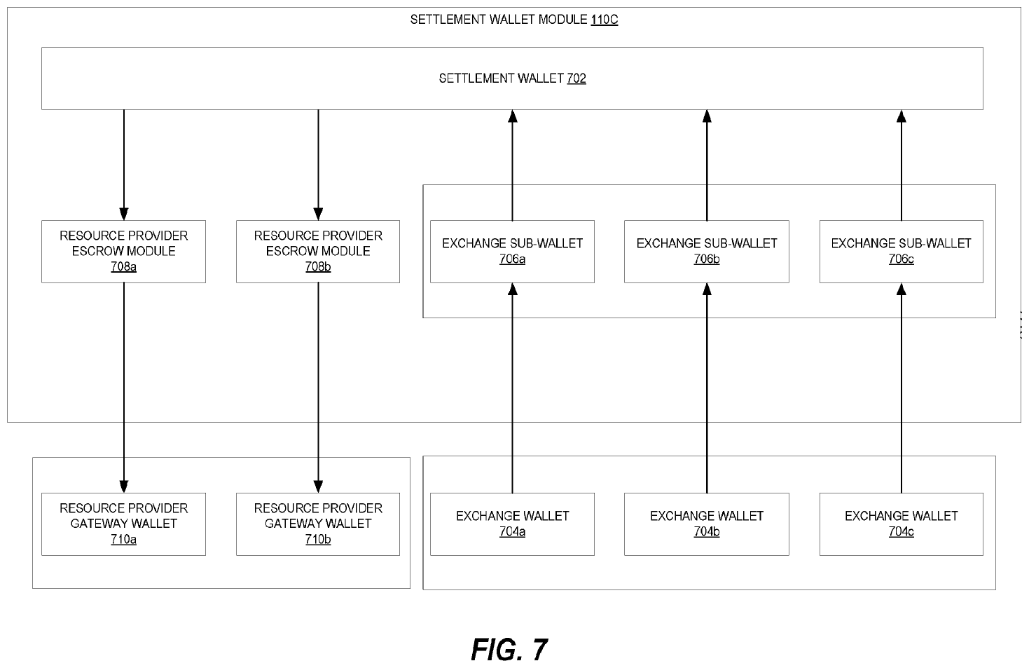

The settlement wallet module 110C can be configured to manage a settlement wallet and sub-wallets associated with the server computer 110. The settlement wallet module 110C can manage transaction requests between a resource provider and a user. For example, the settlement wallet module 110C can confirm the transaction with both the resource provider and the user, and subsequently, record the transaction for settlement. The settlement wallet and sub-wallets will be further described below with reference to FIG. 7.

The exchange API 110D can facilitate interaction, via the network interface 110F with the cryptocurrency exchange computer 150. For example, via the exchange API 110D the cryptocurrency exchange computer 150 can link a user's cryptocurrency account to the user's account with the server computer 110 such that the server computer 110 can access balance information for the user's cryptocurrency wallet. The exchange API 150 can also enable the server computer 110 and the cryptocurrency exchange computer 150 to communicate to update user account and/or user wallet information. The exchange API 110D can also enable the cryptocurrency exchange computer 150 to retrieve transaction and settlement details from the server computer 110.

The gateway API 110E can facilitate interaction, via the network interface 110F, between the server computer 110 and the gateway computer 140. For example, the gateway computer 140 can interact with the server computer 110 on behalf of a resource provider. For example, the gateway API 110E can enable the gateway computer 140 and/or the resource provider computer 130 to retrieve user account information, transaction status information, and transaction details from the server computer 110. The gateway API 110E can also enable the gateway computer 140 or the resource provider 130 to communicate an acceptance or rejection of a transaction to the server computer 110.

In some embodiments, a resource provider can elect to accept a fiat currency, such as the U.S. Dollar, rather than a cryptocurrency. In such a case, the currency exchange module 110H can interact with the cryptocurrency exchange computer 150 to convert cryptocurrency to a fiat currency, which can then be transferred to the resource provider. In some embodiments, a resource provider can have an additional escrow module managed by the settlement wallet module 110C. The resource provider can pre-fund the escrow module such that the funds in the escrow module can be used to cover exchange fees associated with exchanging the cryptocurrency for the fiat currency. In other embodiments, the user may be charged an additional exchange fee.

The memory 110G can be a database, or other memory, physical storage device, or cloud-based storage device. The memory 110G can, for example, store user account and cryptocurrency wallet information. The memory 110G can further include information mapping one or more wallets or sub-wallets to respective resource providers and/or cryptocurrency exchanges.

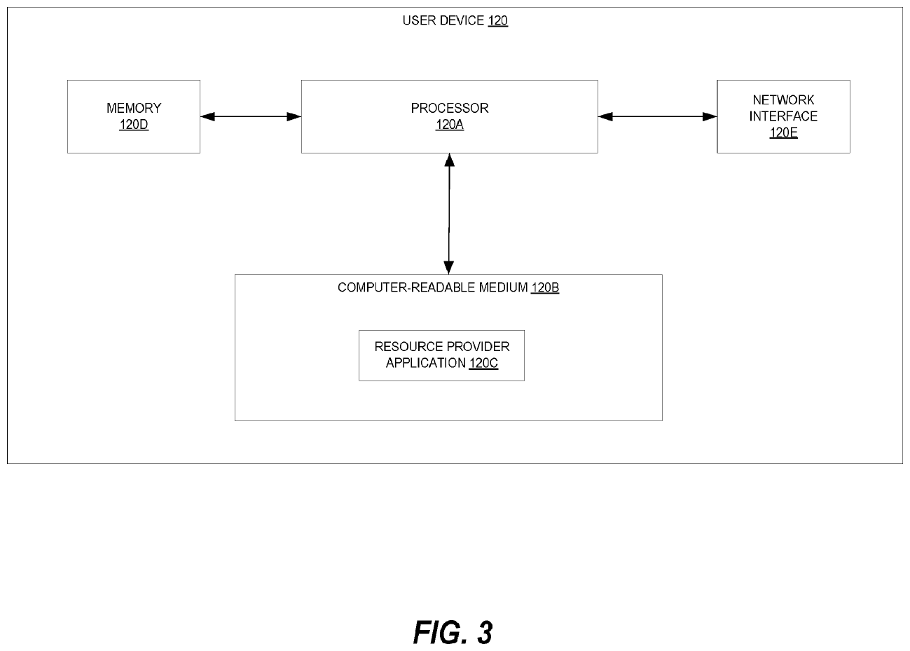

An example of the user device 120 is shown in FIG. 3. In some embodiments, the user device 120 can include components configured to execute the functionality described herein. For example, the user device 120 can include a processor 120A, a computer-readable medium 120B, a network interface 110E, and a memory 110D.

The computer readable medium 120B may include code, executable by the processor 120A for implementing the methods discussed herein. For example, the computer-readable medium 120B can store a resource provider application 120C. The resource provider application 120C can be provided by the resource provider computer 130 via the network interface 120E. The resource provider application 120C can enable a user to conduct a transaction for goods and services with the resource provider. For example, the resource provider application 130 can enable the user to initiate a transaction with the resource provider. In some embodiments, the resource provider application 120C can enable a user to select a payment type, e.g., cryptocurrency, where the cryptocurrency transaction is supported by the server computer 110. The user can then, via the resource provider application 130, authenticate with the server computer 110 and provide information to proceed with and complete the cryptocurrency transaction.

The memory 120D can be a database, or other memory, physical storage device, or cloud-based storage device. The memory 120D can, for example, store user account and cryptocurrency wallet information. The memory 120D can further include information such as a default wallet selection or other configuration information associated with the resource provider application 120C.

As an example, a user can browse an inventory of the resource provider using the resource provider application 120C. The user may select an item from the inventory and proceed to a check out process to purchase the item. During the check out process, the user may be prompted by the resource provider application 120C to select a payment method from a list of available payment methods. In some embodiments, one or more of the payment methods can be supported or facilitated by a third-party payment service provider.

In this example, the user selects cryptocurrency from the list of available payment methods. The user device 120 may then transmit a message to the server computer 110 to initiate the transaction between the user and the resource provider using cryptocurrency to pay for the item. In some embodiments, the user may already have an account with the server computer 110. In other embodiments, the user may be prompted to complete a registration process to create an account. If the user has an existing account or has created an account, the server computer 110 can generate and transmit an OTP via a communication method specified by the user (e.g., via email or text message).

Once the user authenticates with the OTP, the user may be prompted in the resource provider application 120C to select a cryptocurrency wallet from a list of one or more wallets associated with the user's account. After the user has selected the cryptocurrency wallet from the list, the selection is transmitted to the server computer 110 to perform one or more checks on the balance of the wallet. If the wallet is sufficiently funded to complete the transaction (i.e., the wallet balance is greater than the transaction amount), the server computer 110 transmits the transaction details (e.g., the selected wallet, wallet balance, transaction amount, resource provider) to the resource provider application 120C to display to the user. Finally, the user can either authorize or deny the transaction via the resource provider application 110.

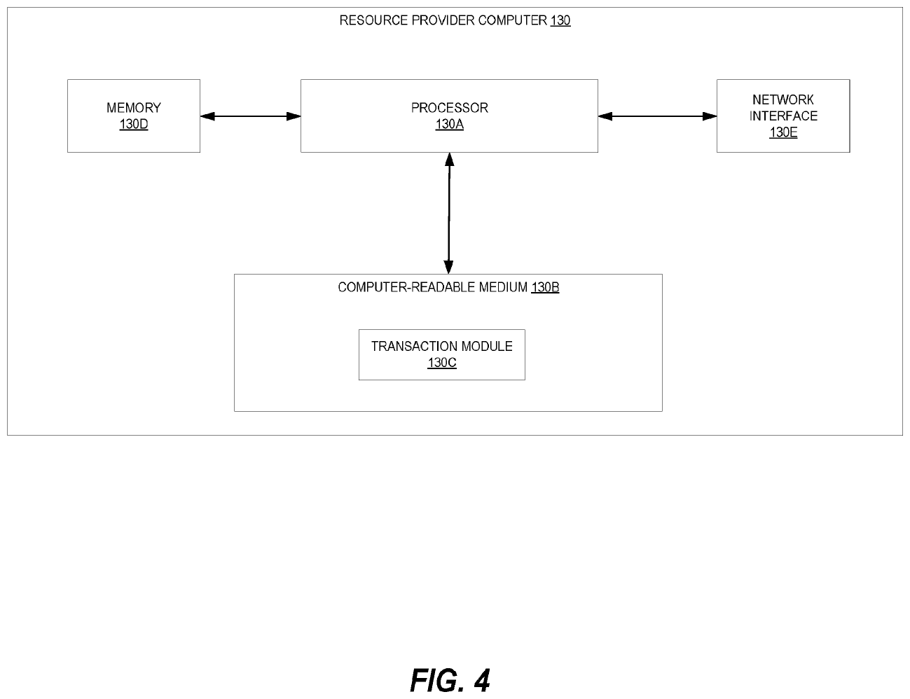

An example of the resource provider computer 130 is shown in FIG. 4. In some embodiments, the resource provider computer 130 can include components configured to execute the functionality described herein. For example, the resource provider computer 130 can include a processor 130A, a computer-readable medium 130B, a network interface 130E, and a memory 130D.

The computer readable medium 130B may include code, executable by the processor 130A for implementing the methods discussed herein. For example, the computer-readable medium 130B can store a transaction module 130C. The transaction module 130C can facilitate interactions, via the network interface 130E, with the server computer 110, user device 120, gateway computer 140, and cryptocurrency exchange computer 150. The transaction module 130C can manage and transmit status notifications and transaction information associated with pending and completed transactions. Further, the transaction module 130C can determine whether or not to accept a pending cryptocurrency transaction and can transmit the acceptance or denial to the server computer 110.

As an example, as part of a cryptocurrency transaction, the resource provider computer 130 can receive, from the server computer 110, transaction details associated with a cryptocurrency transaction between a user and the resource provider. The resource provider computer 130 can analyze the transaction details to determine whether or not to accept the transaction. For example, the transaction module 130 can determine whether the transaction has timed out or whether the good or resource is available. If the transaction can be accepted (e.g., the transaction details meet predetermined requirements), the transaction module 130C can communicate acceptance of the transaction to the server computer 110, causing the server computer 110 to proceed with the cryptocurrency transaction.

The memory 130D can be a database, or other memory, physical storage device, or cloud-based storage device. The memory 130D can, for example, store cryptocurrency wallet information associated with a resource provider wallet. The memory 130D can further include information such requirements or criteria to be met to accept a transaction based on received transaction details.

In some embodiments, the transaction module 130C can be further configured to manage and fund one or more cryptocurrency wallets associated with the resource provider. For example, a resource provider may be associated with an escrow module, or escrow wallet, managed by the server computer 110. The transaction module 130C can monitor the balance of the escrow module to determine if the balance is below a predetermined threshold. If the balance is equal to or below the threshold, the transaction module 130C can communicate with server computer 110 and the cryptocurrency exchange computer 150 to add funds to the escrow module. The balance of the escrow module can, for example, be drawn down in the event a user initiates a chargeback or refund of a transaction.

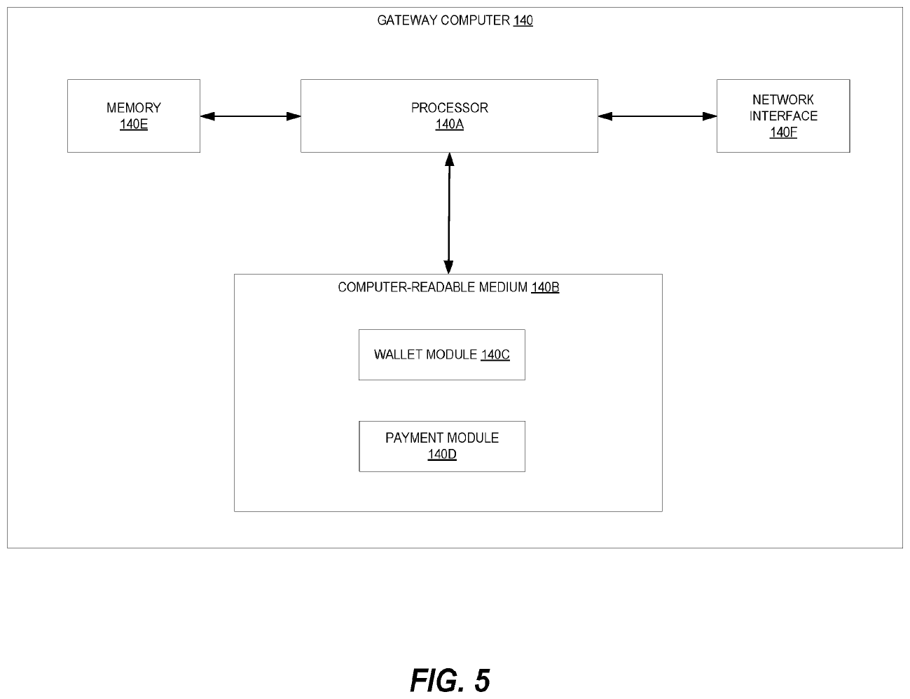

An example of the gateway computer 140 is shown in FIG. 5. In some embodiments, the gateway computer 140 can include components configured to execute the functionality described herein. For example, the gateway computer 140 can include a processor 140A, a computer-readable medium 140B, a network interface 140F, and a memory 140E.

The gateway computer 140 can be associated with a payment service provider and can facilitate transactions between the user, the resource provider, and the server computer 110. For example, a resource provider may be a customer of the payment service provider associated with the gateway computer 140. The gateway computer 140 can communicate with the server computer 110 and/or the cryptocurrency exchange computer 150 on behalf of the resource provider.

The computer readable medium 140B may include code, executable by the processor 120A for implementing the methods discussed herein. For example, the computer-readable medium 120B can store a wallet module 140C and a payment module 140D. The wallet module 140C can manage one or more cryptocurrency wallets associated with one or more resource providers. For example, a resource provider may elect to accept cryptocurrency payment via the service provider platform (e.g., gateway computer 140). The wallet module 140C can transact with the resource provider computer 130 via the network interface 140F to fund the associated cryptocurrency wallet and monitor the wallet's balance. For example, if the balance is less than or equal to a threshold balance, the wallet module 140C can communicate with the resource provider computer 130 to transfer funds or exchange fiat currency for cryptocurrency to fund the associated wallet.

The payment module 140D can manage transactions between a user and resource provider. For example, the payment module 140D can receive the transaction request from the user on behalf of the resource provider computer 130 and can communicate with the server computer 110 to execute the transaction. In some embodiments, the payment module 140D can receive transaction status updates and provide those status updates to the resource provider computer 130.

The memory 140E can be a database, or other memory, physical storage device, or cloud-based storage device. The memory 140E can, for example, store information associated with any resource providers using the payment service provider. The memory 140E can further include information mapping the participating resource providers to their respective cryptocurrency wallets that are managed by the wallet module 140C.

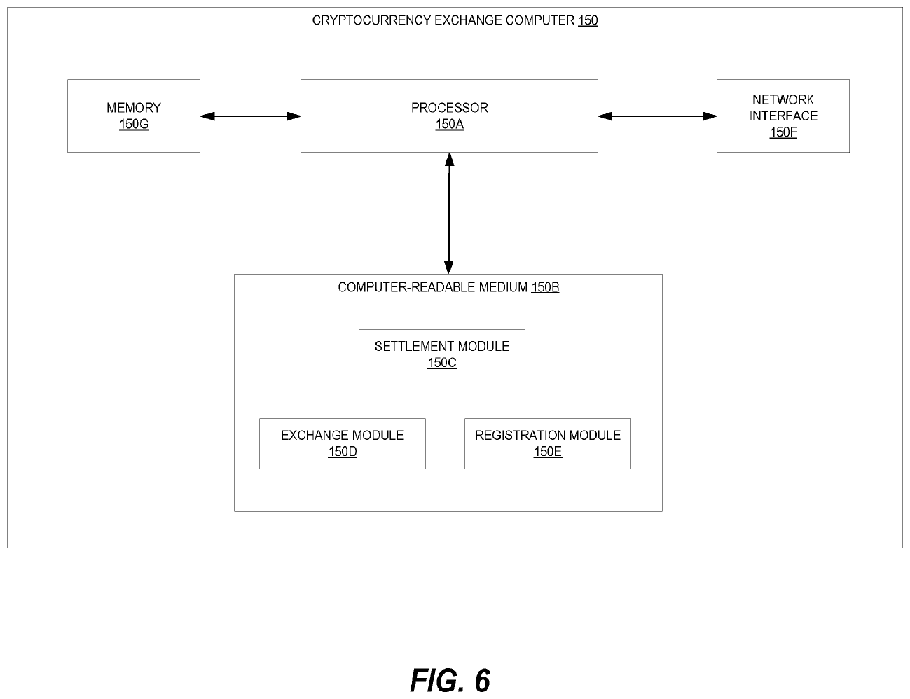

An example of the cryptocurrency exchange computer 150 is shown in FIG. 6. In some embodiments, the cryptocurrency exchange computer 150 can include components configured to execute the functionality described herein. For example, the cryptocurrency exchange computer 150 can include a processor 150A, a computer-readable medium 150B, a network interface 150F, and a memory 150G.

The computer readable medium 150B may include code, executable by the processor 150A for implementing the methods discussed herein. For example, the computer-readable medium 150B can store: a settlement module 150C; an exchange module 150D; and a registration module 150E.

The registration module 150E can include code that, when executed, causes the processor 150A to receive registration information associated with a user associated with a cryptocurrency wallet managed by the cryptocurrency exchange computer 150. Further, the registration module 150E can communicate with the server computer via the exchange API 110D to create an account for a user with the server computer 110. For example, the registration module 150E can receive an account creation request from a user. In response to the request, the registration module 150E can link one or more cryptocurrency wallets associated with and selected by the user to the user's account with the server computer 110.

In some embodiments, the registration module 150E can be configured to provide to the server computer 110 a listing of the cryptocurrency wallets associated with the user and/or their respective balances. For example, the registration module 150E can receive a query from the server computer for a list of wallets associated with a user and can return, via the exchange API 110D using the network interface 150F, the list of wallets. In another example, the registration module 150E can receive a balance query from the server computer 110 for a particular cryptocurrency wallet associated with the user. The registration module 150E can determine the balance for the particular wallet and return the balance, via the exchange API 110D using the network interface 110F, to the server computer 110.

The exchange module 150F can include code that, when executed, causes the processor 150A to generate transaction records associated with a transaction. For example, the exchange module 150F can receive a cryptocurrency transaction request from the server computer 110 where the transaction request is associated with a cryptocurrency transaction between a user and a resource provider. The transaction request can include a selection of a cryptocurrency wallet associated with the user, a transaction amount, and an address of the resource provider wallet.

The exchange module 150F can record the transaction of funds as a series of sub-transactions: from the user's selected wallet to an exchange wallet; from the exchange wallet to the settlement wallet of the server computer 110; from the settlement wallet of the server 110 to a wallet managed by the gateway computer 140 and associated with the resource provider; and from the wallet managed by the gateway computer 140 and associated with the resource provider to a wallet of the resource provider. The exchange module 150F can record, for example, the “to” and “from” addresses of the wallets involved in each sub-transaction, the transaction amount, and a transaction status.

In some embodiments, the exchange module 150F can also place a hold or a soft block on funds in the user's cryptocurrency account in the transaction amount. Thus, the user cannot double-spend the funds involved in the pending transaction.

The settlement module 150D can include code that, when executed, causes the processor 150A to clear and settle the transactions described by the transaction records. For example, the settlement module 150D can receive a set of transactions that occurred during a predefined time period and, at predetermined intervals, settle the recorded transactions on the blockchain associated with the cryptocurrency.

The memory 150G can be a database, or other memory, physical storage device, or cloud-based storage device. The memory 150G can, for example, store pending and completed transaction records. The memory 150G can further store settlement information, such as the settlement interval.

FIG. 7 illustrates an exemplary settlement wallet module 110C of the server computer 110. The settlement wallet module 110C, as described above, can be configured to facilitate real-time transactions between a user and a resource provider that are later settled with the cryptocurrency exchange computer 150.

The settlement wallet module 110C can manage a settlement wallet 702 of the server computer 110. The settlement wallet 702 can function as an intermediary during cryptocurrency transactions between a user and a resource provider. In some embodiments, the settlement wallet 702 can be managed by the server computer 110 and hosted on a low-latency, high-speed blockchain network.

When a cryptocurrency exchange is onboarded to the platform hosted by the server computer 110, the settlement wallet module 110C can create a pre-funded exchange sub-wallet 706a associated with an exchange wallet 704a of the cryptocurrency exchange. Thus, for each onboarded cryptocurrency exchange, there is an exchange wallet 704a, 704b, 704c, etc. associated with an exchange sub-wallet 706a, 706b, 706c, etc., respectively, where the exchange sub-wallets are managed by the server computer 110. In some embodiments, the server computer 110 can move funds to settle recorded transactions from each exchange sub-wallet 706 to the settlement wallet 702 at predetermined intervals. The intervals can be, for example, an agreed upon interval between the cryptocurrency exchange associated with the sub-wallet and the administrator of the server computer 110.

Each exchange sub-wallet 706 can be an individual wallet associated with its own public-private key pair such that it can transact with its associated exchange wallet 704, managed by the cryptocurrency exchange computer 150. In some embodiments, each exchange sub-wallet 706 can transfer funds to other wallets or entities by cryptographically signing transactions and then having those signed transactions recorded on an appropriate blockchain. In other embodiments, each exchange sub-wallet 706 can be owned by the settlement wallet module 110C, and can be managed by a cryptocurrency exchange computer. In other embodiments, an exchange sub-wallet 706 can be a partition of the settlement wallet 702 in which particular funds held by the settlement wallet 702 are tagged to the particular exchange.

In some embodiments, a transaction request can identify a selection of a cryptocurrency wallet of the user, where the cryptocurrency wallet is managed by a cryptocurrency exchange. The server computer 110 can determine the balance of the exchange sub-wallet 706 associated with the cryptocurrency exchange and compare the balance to the requested transaction amount. If the balance is less than the transaction amount, the server computer 110 can deny the transaction requests. In some embodiments, the server computer 110 can transmit a notification to the cryptocurrency exchange computer 150 indicating a low balance in the exchange sub-wallet 706, thereby causing the cryptocurrency exchange computer 150 to execute a transaction of funds from the exchange wallet 704 to the exchange sub-wallet 706.

In another embodiment, the server computer 110 and/or the cryptocurrency exchange computer 150 can monitor the associated exchange sub-wallet 706 to determine if the balance of the exchange sub-wallet 706 drops below a predetermined threshold. If the balance drops below the threshold, the server computer 110 can transmit a notification to the cryptocurrency exchange computer 150 indicating a low balance in the exchange sub-wallet 706, thereby causing the cryptocurrency exchange computer 150 to execute a transaction of funds from the exchange wallet 704 to the exchange sub-wallet 706. In another embodiment, the cryptocurrency exchange computer 150 can monitor the balance and automatically transfer funds when the balance is less than the threshold.

The settlement wallet module 110C can also manage and record direct or indirect transactions with a resource provider gateway wallet 710. The resource provider gateway wallet 710 can be associated with a particular resource provider using the payment service provider associated with the gateway computer 140. In some embodiments, the gateway computer 140 can manage multiple resource provider gateway wallets associated with different resource providers (e.g., wallets 710a and 710b). In another embodiment, multiple gateway computers 140 can manage multiple resource provider gateway wallets. In some embodiments, the resource provider gateway wallets 710 can be hosted on the server computer 110. In other embodiments, the resource provider gateway wallets 710 can be hosted by a third-party (e.g., cryptocurrency exchange computer 150).

Each of the resource provider gateway wallet 710 can be associated with a resource provider escrow module 708 managed by the server computer 110. In some embodiments, the resource provider escrow module 708 can be managed by a custody computer system (e.g., Fireblocks™). Each resource provider escrow module 708a, 708b, etc. can be associated with a resource provider gateway wallet 710a, 710b, etc. respectively. The resource provider escrow module 708 can be configured to carry a balance of funds that can be used in the event that a user requests a chargeback or refund of a cryptocurrency transaction. In some embodiments, each resource provider escrow module 708 can be a partition of the settlement wallet 702 in which particular funds held by the settlement wallet 702 are tagged to the particular resource provider. In other embodiments, each resource provider escrow module 708 can be a separate sub-wallet that has its own public-private key pair.

When a cryptocurrency transaction is recorded, the settlement wallet module 110C may record one or more sub-transactions. For example, the settlement wallet module 110C can record sub-transactions: from the user's selected wallet for the transaction to the exchange wallet 704; from the exchange wallet 704 to the settlement wallet 702 of the server computer 110; from the settlement wallet 702 of the server 110 to a resource provider gateway wallet 710 managed by the gateway computer 140 and associated with the resource provider; and from the resource provider gateway wallet 710 to a wallet of the resource provider.

In some examples, a user, via the user device 120, can request a refund of a cryptocurrency transaction with a resource provider. In the event of a refund, the settlement wallet module 110C can record transactions in the refund amount from the resource provider escrow module 708 to the settlement wallet 702, from the settlement wallet 702 to the exchange wallet 704 associated with the cryptocurrency wallet of the user that was used to fund the original transaction, and from the exchange wallet 704 to the cryptocurrency wallet of the user. In some embodiments, the server wallet module 110C can include gateway escrow modules associated with and managed by the gateway computer 140. For example, the server computer 110 can include a plurality of gateway escrow modules for a plurality of gateway computers (e.g., gateway computer 140) in communication with a plurality of resource provider computers (e.g., resource provider computer 130).

In some embodiments, the server computer 110 and/or the gateway computer 140 can monitor the balance of each resource provider escrow module 708. If the escrow module balance drops below the threshold, the server computer 110 can transmit a notification to the gateway computer 140 indicating a low balance in the resource provider escrow module 708. The getaway computer 140 can then initiate a transaction to fund the resource provider escrow module 708 from the resource provider gateway wallet 710. In another embodiment, the gateway computer 140 can monitor the escrow balance and automatically transfer funds to the resource provider escrow module 708 when the balance is less than the threshold.

In some embodiments, the settlement wallet module 110C can be configured to settle recorded transactions at predetermined interval. For example, the server computer 110 can receive a predetermined amount of funds from a cryptocurrency exchange computer 150. The predetermined amount of funds can be stored in an exchange sub-wallet 704 of the server computer that is associated with the cryptocurrency exchange computer 150. For example, the cryptocurrency exchange computer 150 can pre-fund its associated exchange sub-wallet 704, which is managed by the settlement wallet module 110C, from its associated exchange wallet 706, which is managed by the cryptocurrency exchange computer 150 itself.

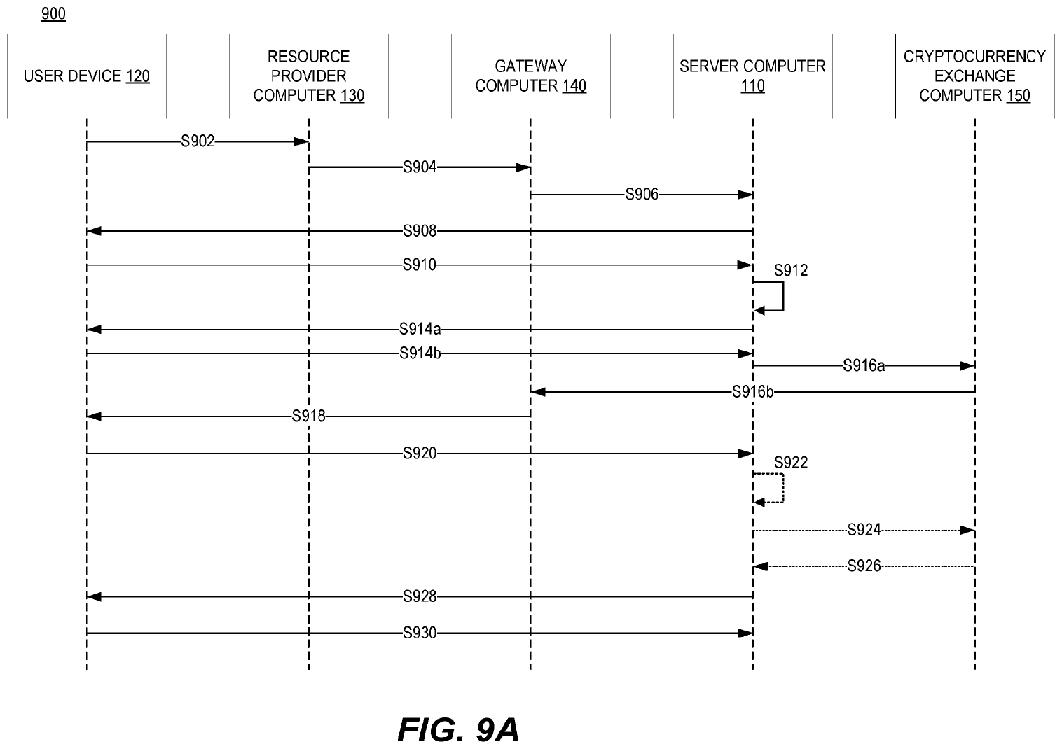

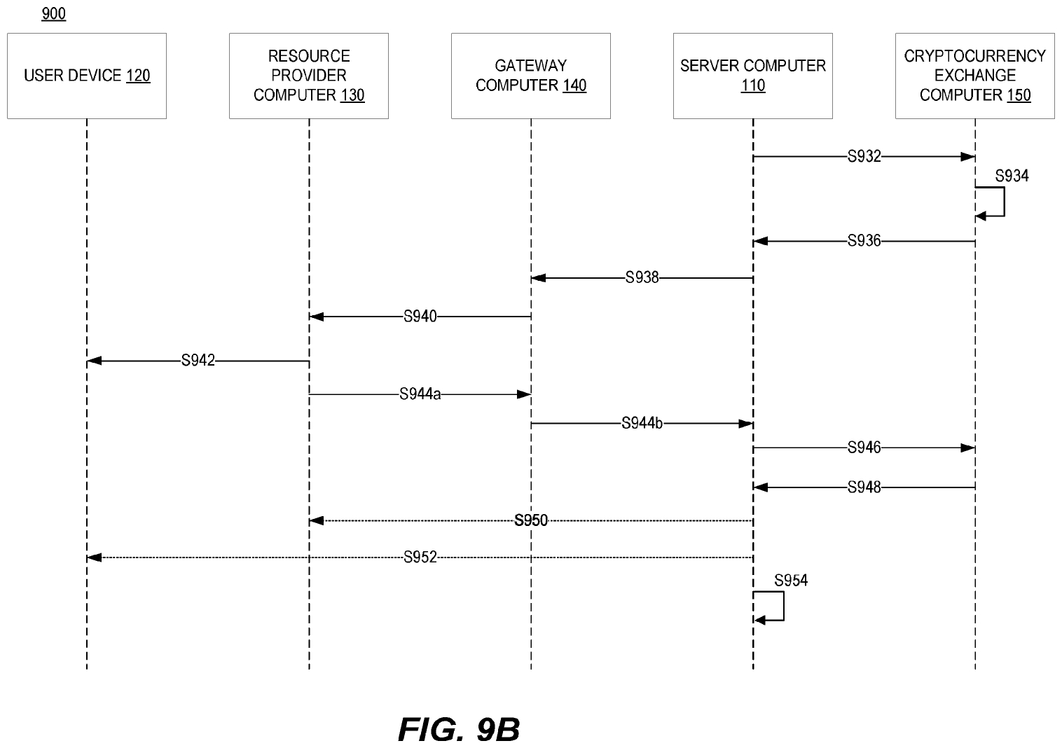

When a transaction occurs between a user and a resource provider, the server computer 110 can receive transaction information associated with the transaction between a user and a resource provider. The transaction information can include a transaction amount and can be associated with a cryptocurrency exchange computer 150. For example, the transaction information can indicate a user's cryptocurrency wallet from which to fund the transaction that is associated with the cryptocurrency exchange of the cryptocurrency exchange computer 150. As described below with reference to FIGS. 9A and 9B, the server computer 110 can record the transaction off-chain for later on-chain settlement.

At a first predetermined interval, the server computer 110, can transfer funds in the transaction amount from the exchange sub-wallet 704 to a settlement wallet 702.

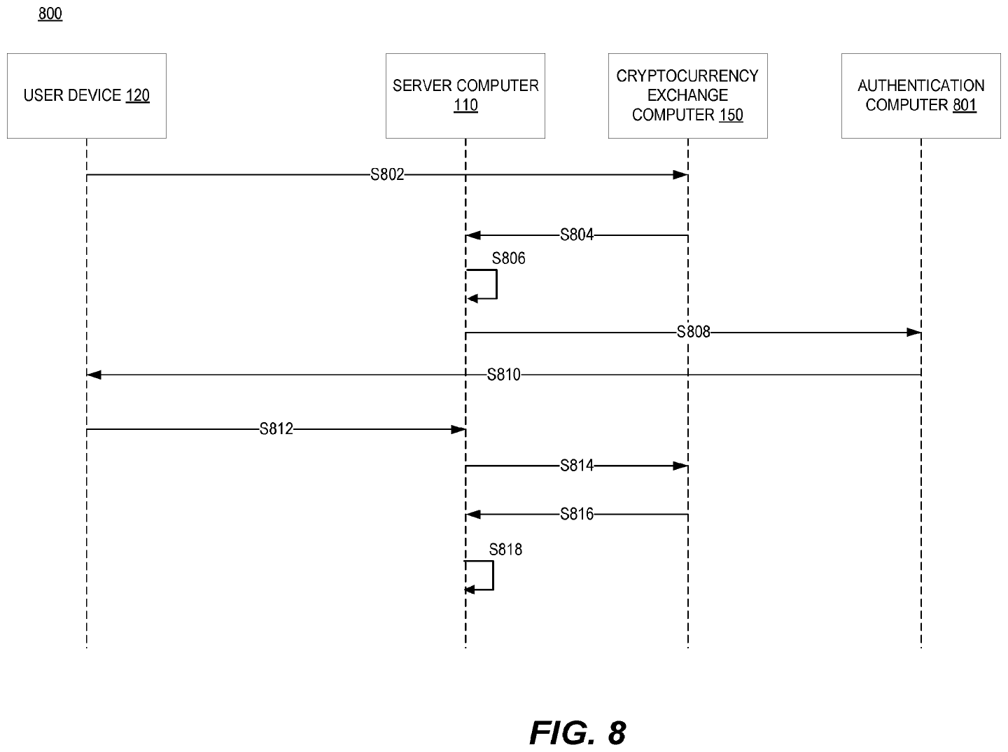

A process 800 according to examples of the present application can be described with respect to FIG. 8. The process 800 enables a user to register an account with the server computer 110 and link a cryptocurrency wallet managed by the cryptocurrency exchange computer 150 to the server computer 110.

At step S802, the process 800 can include receiving, by the cryptocurrency exchange computer 150, a request from a user to create an account with the server computer 110. The request can include user information such as an email address, phone number, a selection of one or more cryptocurrency wallets, cryptocurrency wallet access approval (e.g., approval to read the cryptocurrency wallet and access a balance of the cryptocurrency wallet), etc.

At step S804, the process 800 can include providing, via the exchange API 110D, the user information to the server computer 110. For example, the server computer 110 can receive the registration request associated with the user of the user device 120. The registration request can be associated with a request to link the cryptocurrency wallet of the user with the server computer 110.

At step S806, the process 800 can include initiating, by the server computer 110, the user account using the received user information.

In some embodiments, at step S808, the server computer 110 can initiate an authentication process with a separate authentication computer 801 to authenticate the user. The authentication computer 801 can be, for example, an external server configured to generate OTPs and authenticate users with the OTPs.

At step S810, the authentication computer 801 can generate an OTP and transmit the OTP to the user via a communication pathway provided by the user (e.g., email or text message). The OTP can be provided to the user and entered by the user in a cryptocurrency exchange application or a resource provider application 120C.

In some embodiments, the generation and transmission of the OTP to the user device 110 can be completed by the server computer 110 or an authentication module of the server computer 110.

At step S812, the process 800 can include transmitting the entered OTP form the user device 120 to the server computer 110 for authentication. The server computer can compare the generated OTP with the entered OTP. If the OTPs do not match, an error message can be transmitted from the server computer 110 to the user device 120 and/or the cryptocurrency exchange computer 150. If the OTPs match, the user can be authenticated.

If the user is authenticated by the server computer 110, at step S814, the process 800 can include transmitting a message to the cryptocurrency exchange computer 150 indicating the successful creation of the user account. In response to receiving read and access permission in the registration request, the cryptocurrency computer 150 can link the selected cryptocurrency wallet with the newly created user account on the server computer 110.

At step S816, the process 800 includes receiving, by the server computer 110, information associated with the linked cryptocurrency wallet. This information can include a cryptocurrency wallet address and a wallet balance. In some embodiments, the server computer 110 and/or the cryptocurrency exchange computer 150 can transmit a notification to the user device 120 indicating that the user account was successfully created and the selected cryptocurrency wallet was linked with the server computer 110.

At step S818, the process 800 can include storing, by the server computer 110, the user account and cryptocurrency wallet information in a database accessible to or managed by the server computer 110.

Accordingly, the process 800 can enable a user to create an account with the server computer 110 and link a cryptocurrency wallet with the server computer 110. In some embodiments, this process can be initiated and completed through an application provided on the user device 120 by the cryptocurrency exchange computer 150. In another embodiment, this process can be initiated and completed via the resource provider application 120C as part of a check out or payment process.

A process 900 according to examples of the present application can be described with respect to FIGS. 9A and 9B. The process 900 enables a user to complete a cryptocurrency transaction with a resource provider. The cryptocurrency transaction can be completed using the account created by the user with the process 800.

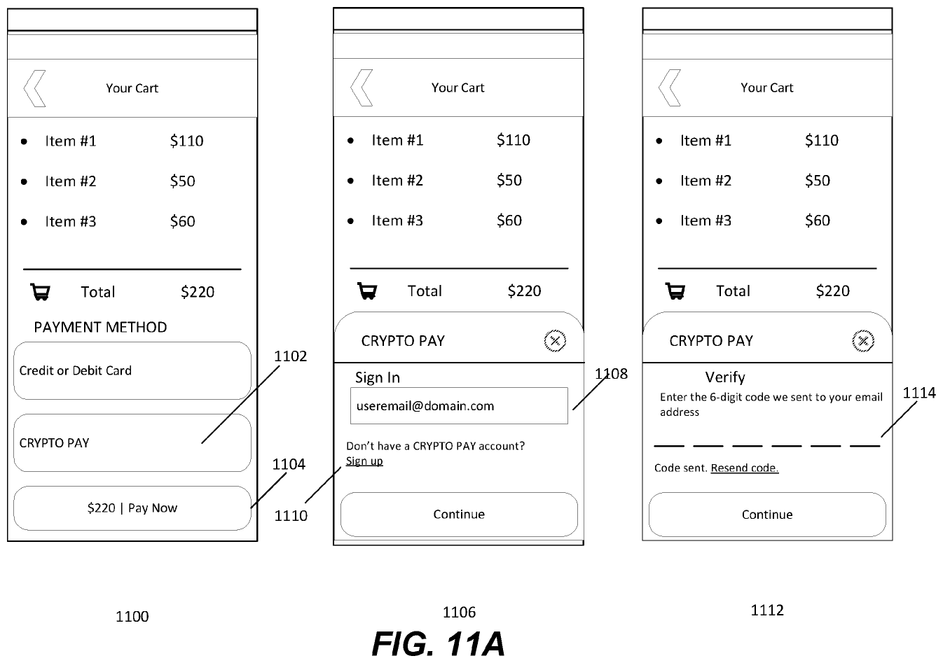

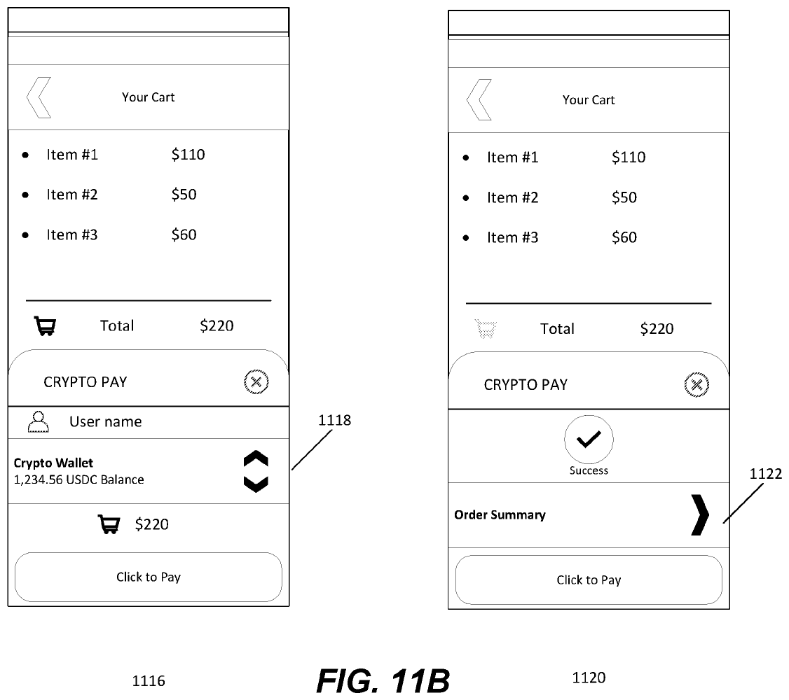

The process 900 will be described in conjunction with FIGS. 11A and 11B, which provide illustrations of exemplary interfaces displayed by the user device 120 during a cryptocurrency transaction according to the process 900.

At step S902, the process 900 can include a user initiating a cryptocurrency transaction via the user device 120. For example, the user can interact with a resource provider application 120C on the user device 120 to conduct a transaction with a resource provider. The server computer 110 can receive the transaction request for a cryptocurrency transaction from a user associated with the user device 120 to a resource provider associated with a resource provider computer 130. In some embodiments, the transaction request can include an indication of a cryptocurrency wallet associated with the user and a transaction amount. The cryptocurrency wallet can include a funding source. For example, the cryptocurrency wallet can hold a balance of one or more cryptocurrencies.

As an example, the user can generate a cart while shopping with a resource provider via the resource provider application 120C. The user can initiate a checkout process via the resource provider application 120C causing the user device 120 to display a GUI 1100, shown in FIG. 11A. The GUI 1100 can, for example, display items in the user's cart, the transaction total, and payment options. In disclosed embodiments, the GUI 1100 can include an option 1102 to complete the transaction using cryptocurrency. The user can select the option 1102 to pay for the transaction with cryptocurrency and can select the button 1104 to initiate the cryptocurrency transaction with the resource provider.

At step S904, the process 900 can transmitting the transaction request to the gateway computer 140. In some embodiments, the user may be redirected from the resource provider application 120C to a gateway application to sign into their account with the server computer 110. In another embodiment, the user can complete authentication from the resource provider application 120C.

At step S906, the process 900 can include, transmitting a request from the gateway computer 140 to the server computer 110 to authenticate the user. In some embodiments authentication of the user can be executed by a separate authentication server (e.g., authentication computer 801).

At step S908, the server computer 110 can cause the user device 120 to prompt the user to enter identification such as an email address or phone number that is associated with the user's account with the server computer 110.

As an example, as shown in FIG. 11A, the user device 120 can display a GUI 1106. The GUI 1106 can include an input field 1108 where the user can enter their email address or phone number associated with their account. If the user does not have an account with the server computer 110, the user can select the link 1110 to initiate process 800 described above to create an account.

Returning to FIG. 9A, at step S910, the user device 120 can transmit the input information to the server computer 110.

At step S912, the server computer 110 can query a user account database using the provided email address or phone number to confirm that the user has an account with the server computer 110.

At step S914a, the server computer 110 can generate an OTP and transmit the OTP to the user via the selected communication method (e.g., by email, text message, phone call, etc.). With reference to FIG. 11A, in response to the server computer 110 transmitting the OTP to the user device 120, the resource provider application 120C display a GUI 1112 to prompt the user to enter the OTP at input field 1114.

At step S914b, the user device 120 transmits the entered OTP to the server computer 110 for verification. The server computer 110 can compare the generated OTP with the entered OTP to authenticate the user. In some embodiments, the authentication can be handled by an external server or system (e.g., authentication computer 801), which can communicate with the server computer 110.

At step S916a, the process 900 can include transmitting, by the server computer 110, a message to the cryptocurrency exchange computer 150 indicating that the authenticated user has initiated a cryptocurrency transaction. The message can include account information such as a username, account ID, user ID, or other information for identifying the user account.

At step S916b, the cryptocurrency exchange computer 150 can identify a list of one or more cryptocurrency wallets associated with the user and/or user account and transmit the list to the gateway computer 140. For example, the cryptocurrency exchange computer 150 can use the received account information to identify an exchange account of the user. The exchange account of the user can enable the user to manage one or more cryptocurrency wallets. The cryptocurrency exchange computer 150 can return the list of cryptocurrency wallets, including, for each wallet, a user ID, an exchange name, a wallet ID, and a currency held in the wallet.

At step S918, the gateway computer 140 can transmit the list of one or more cryptocurrency wallets to the user device 120. As shown in FIG. 11B, the user device 120 can display a GUI 1116 including a selectable list 1118 of cryptocurrency wallets associated with the user account. In some embodiments, the GUI 1116 can also display the balance of funds in each linked cryptocurrency wallet.

At step S920, the user device 120 transmits an indication of the selected cryptocurrency wallet to the server computer 110. In some embodiments, the user device 120 can automatically default to a preset default cryptocurrency wallet identified by the user during account registration. In other embodiments, when a user account is associated with a single cryptocurrency wallet, the single cryptocurrency wallet can be automatically selected, thereby eliminating the need for steps S918 and S920.

In some embodiments, the gateway computer 140 can receive the user's wallet selection and generate a transaction intent message. The transaction intent message can include a merchant ID (e.g., resource provider ID), a user ID (e.g., an ID of the paying entity), the wallet ID of the selected wallet, a unique transaction ID, a currency code that maps to the type of currency selected for the transaction, a network type that supports the selected currency, and a transaction amount in the selected currency. This transaction intent message can be transmitted to the server computer 110 to initiate the transaction between the user and the resource provider using the selected wallet and currency.

The process 900 can also include optional steps S922 and S924. At step S922, the server computer 110 determines whether the exchange sub-wallet 706 associated with the cryptocurrency exchange computer 150 has enough funds to complete the transaction. For example, the server computer 110 can compare the exchange sub-wallet balance to the transaction amount. If the exchange sub-wallet balance is less than the transaction amount, the server computer 110 can transmit an error message to the cryptocurrency exchange computer 150 and/or the user device 120 indicating that the cryptocurrency transaction cannot be processed. In some embodiments, the server computer 110 can compare the exchange sub-wallet balance with the transaction amount plus a buffer amount configured to cover fees associated with settlement of the transaction. The server computer 110 can proceed with process 900 if the exchange sub-wallet is holding funds greater than or equal to the transaction amount, or the transaction amount plus the buffer.

In some embodiments, server computer 110 can determine whether an available balance of the exchange sub-wallet 704 is greater than or equal to the transaction amount. For example, the available amount can be the actual balance of the exchange sub-wallet 704 minus a settlement position of the cryptocurrency exchange. The settlement position can be based on transactions during a given time period that have been recorded by the server computer 110, but have not yet been settled.

The process 900 can also include an optional step S924 in which the server computer 110 communicates with the cryptocurrency exchange computer 150 associated with the cryptocurrency wallet to determine that the balance of the funding source is greater than or equal to the transaction amount.

At step S926, the cryptocurrency exchange computer 150 can determine the balance of funds associated with the selected account and transmit the balance to the server computer 110. The server computer 110 can then compare the balance with the transaction amount. If the balance of the selected cryptocurrency wallet is less than the transaction amount, the server computer 110 can transmit an error message to the cryptocurrency exchange computer 150 and/or the user device 120 indicating that the cryptocurrency transaction cannot be processed. In some embodiments, the user may be prompted to select a different wallet from the list of available cryptocurrency wallets with which to complete the transaction.

If the balance of the cryptocurrency wallet is greater than or equal to the transaction amount, at step S928, the server computer 110 may transmit a message to the user device 120 requesting confirmation of the transaction. The message can include transaction details, such as the selected wallet, wallet balance, transaction amount, and resource provider. For example, the server computer 110 can provide, to the user device 120, transaction details including the funding source, the transaction amount, and the balance of the funding source in the cryptocurrency wallet.

At step S930, responsive to input by the user, the server computer 110 receives confirmation of the cryptocurrency transaction from the user device 120. The confirmation can cause the server computer 110 to proceed with the process 900 to complete the cryptocurrency transaction.

Referring now to FIG. 9B, at step S932, the server computer 110 can transmit the transaction details to the cryptocurrency exchange computer 150. In addition to the transaction details, the server computer 110 can transmit an address associated with a cryptocurrency wallet of the resource provider. In some embodiments, the server computer 110 can transmit an instruction to the cryptocurrency exchange computer 150 to place a hold on the funding source for the transaction amount.

At step S934, the cryptocurrency exchange computer 150 can put a hold on funds in the user's cryptocurrency wallet in the transaction amount. For example, the funds can be held or blocked to prevent double spending of funds that are part of the pending cryptocurrency transaction. By holding or blocking the funds, they are prevented from being used, for example, to settle a different transaction prior to settling the pending transaction.

At step S936, the cryptocurrency exchange computer 150 can notify the server computer 110 that the transaction was successfully processed. At step S938, the server computer 110 provides an authorization message to the resource provider computer 130 indicating authorization of the cryptocurrency transaction. In some embodiments, this notification is communicated to the gateway computer 140, which transmits the transaction details and notification of success to the resource provider computer 130 at step S940. In some embodiments, the server computer 110 can directly transmit the notification of success to the user device 120.

In other embodiments, at step S942, the resource provider computer 130 transmits the notification of success to the user device 120. As an example, shown in FIG. 11B, a GUI 1120 can display an indication that the transaction was successful. In some embodiments, the GUI 1120 can include a selectable tab 1122 to open the transaction details.

Returning to FIG. 9B, at step S944a, the resource provider computer 130 can review or analyze the transaction details to determine whether to accept the cryptocurrency transaction. As discussed above, the resource provider computer 130 may compare the transaction details to one or more thresholds or criteria to determine if the transaction can be accepted. If the cryptocurrency transaction can be accepted, the resource provider computer 130 can transmit an acceptance message indicating acceptance of the transaction to the gateway computer 140, which transmits the acceptance message indicating acceptance to the server computer at step S944b. In some embodiments, the acceptance can be communicated directly to the server computer 110, which receives the acceptance message from the resource provider computer 130.

In some examples, a merchant can deny the transaction, for example, if the merchant does not accept the selected cryptocurrency. In such a case, the user can be prompted, via the user device 120 to select a different payment method or different cryptocurrency.

At step S946, the server computer 110 notifies the cryptocurrency exchange computer 150 of the acceptance of the transaction. Upon notification of acceptance, the cryptocurrency exchange computer can transfer the blocked funds from the user's selected cryptocurrency wallet to the exchange wallet 704. For example, the server computer 110 can provide, to the cryptocurrency exchange computer 150, the acceptance message, thereby causing a transfer of cryptocurrency funds in the transaction amount from the funding source to an account of the resource provider associated with the resource provider computer 130 to occur.

Once the transfer is complete, at step S948, the cryptocurrency exchange computer 150 transmits a success notification to the server computer 110. In some embodiments, the server computer 110 can transmit confirmation of the transaction to the resource provider computer 130 at step S950, and to the user device 120 at step S952.

At step S954, the server computer 110 can record the transaction. Once the transaction is recorded, it can be cleared and settled at a time predetermined by the server computer 110.

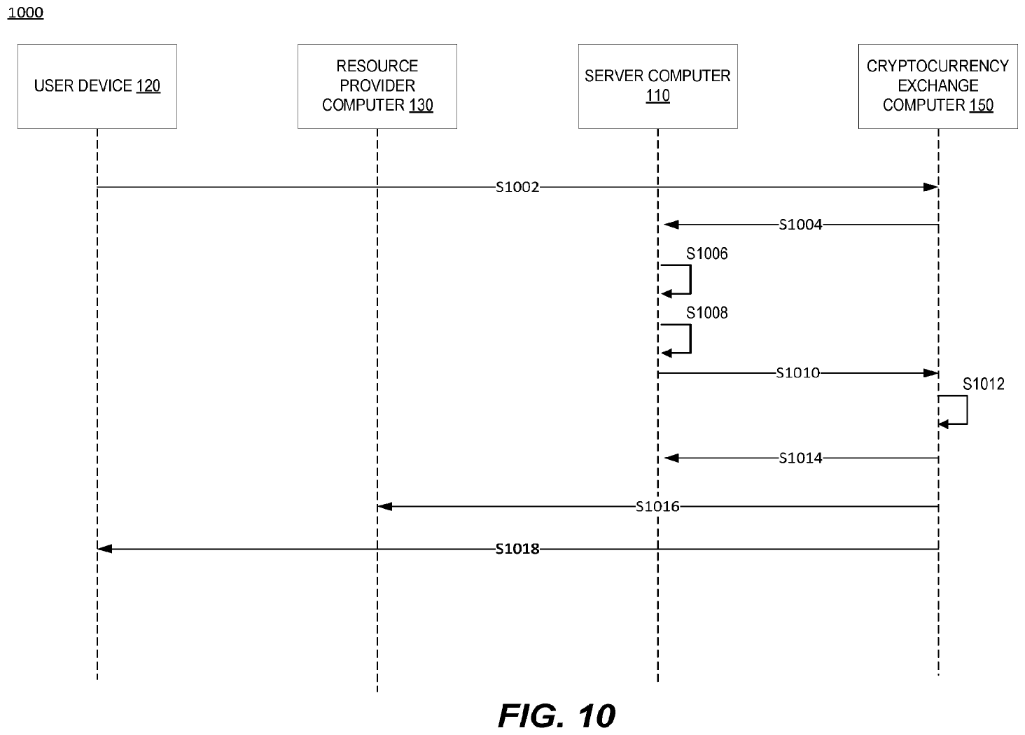

A process 1000 according to examples of the present application can be described with respect to FIG. 10. The process 1000 enables a user to complete a refund of a cryptocurrency transaction with a resource provider.

At step S1002, a user can initiate a refund causing the user device 120 to communicate a refund request to the cryptocurrency exchange computer 150. The refund request can include, for example, a transaction ID, a user ID, and an indication of the cryptocurrency wallet used to complete the transaction.

At step S1004, the cryptocurrency exchange computer 150 transmits the refund request to the server computer 110. In some embodiments, the server computer 110 can use the transaction ID to lookup the recorded transaction and determine the transaction amount and a resource provider with which the original transaction occurred. For example, the server computer 110 can receive, form the cryptocurrency exchange computer 150, a refund request for a refund from a resource provider to a user. The refund request can include an indication or address of the cryptocurrency wallet used for the transaction and associated with the user and a refund amount (i.e., the amount of the original transaction).

At step S1006, the server computer draws down funds in the transaction amount from the resource provider escrow module 708 associated with the resource provider and into the settlement wallet 702 of the server computer 110. For example, the server computer 110 can transfer the refund amount from a gateway escrow module (e.g., the resource provider escrow module 708) associated with the resource provider to the settlement wallet 702 of the server computer 110. The resource provider escrow module 708 enables funds to be immediately available for transfer in the event of a refund request.

At step S1008, the server computer 110 transfers the funds from the server wallet 702 to the exchange sub-wallet 706, associated with the cryptocurrency exchange computer 150. The funds in the exchange sub-wallet 706 are then available to the exchange wallet 704 of the cryptocurrency exchange computer 150.

At step S1010, the server computer 110 notifies the cryptocurrency exchange computer 150 of the transferred funds. For example, the server computer 110 can provide a refund message to the cryptocurrency exchange computer 150, causing a transfer of cryptocurrency funds in the refund amount from the resource provider wallet to a cryptocurrency wallet of the user to occur.

At step S1012, the cryptocurrency exchange computer 150 can transfer the funds from the exchange sub-wallet 706 or the exchange wallet 704 to the user's cryptocurrency wallet to complete the refund.

In some embodiments, the server computer 110 can record the refund transaction for settlement at a predetermined interval. The server computer 110 can determine a net settlement position of, for example, the exchange sub-wallet 706 that is based on any transaction amounts less any refund amounts during the time period between settlements.

Once the refund is complete, at step S1014, the cryptocurrency exchange computer 150 transmits a notification to the server 110. For example, the notification can indicate the status of the return transaction so a status of the original transaction can be updated and recorded.

At steps S1016 and S1018, the cryptocurrency exchange computer 150 can transmit notifications to the resource provider computer 130 and the user device 120, respectively. The notifications can indicate, for example, that a refund was initiated and processed and that funds were successfully transferred to the user's cryptocurrency wallet.

Accordingly, process 1000 facilitates a refund between a resource provider and a user. By managing the resource provider escrow module 708, the server computer 110 can facilitate an efficient refund to the user without a delay associated with transacting from the resource provider's cryptocurrency wallet to the user's cryptocurrency wallet.

Disclosed embodiments present several advantages over current cryptocurrency payment technologies. For example, disclosed systems and methods enable seamless and efficient cryptocurrency payment and refunds for everyday transactions. The disclosed systems and methods enable the server computer 110 to handle authorization of a transaction or refund and act as an intermediary, guaranteeing fund availability from the user's cryptocurrency account and the exchange's sub-wallet managed by the server computer for multiple layers of transaction protection.

The disclosed systems and methods easily integrate into existing resource provider applications and payment service provider platforms. For example, a resource provider or payment service provider can use the flexible cryptocurrency transaction framework to implement tailored in-application experiences for users to complete a checkout process using cryptocurrency. Further, the structure of the settlement wallet module 110C which includes server computer-managed sub-wallets for each exchange, enables users, resource providers, and exchanges to execute transactions through a centralized platform. The exchange sub-wallets reduce the required communication with the associated exchange during a transaction, thereby increasing efficiency and facilitating a seamless transaction process. The exchange sub-wallets, which are managed by the server computer, enable the server computer to facilitate efficient transactions by controlling the frequency of settlements involving the exchange sub-wallets.

In addition to improved efficiency, the disclosed systems and methods offer improved transaction security and reliability to the user and the resource provider. For example, by requiring a user account with the server computer 110, disclosed embodiments facilitate a “know-your-customer” (KYC) framework. By collecting user information and authenticating the user, the server computer 110 reduces the risk of the cryptocurrency payment platform being abused for nefarious transactions by unknown entities. By linking transactions to known users and resource providers, transactions can be traced to an individual and/or business entity.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or integrated circuit assemblies memory such as a flash memory or a solid state storage, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive, and that embodiments are not to be limited to the specific arrangements and constructions shown and described, since various other modifications may occur to those with ordinary skill in the art.

As used herein, the use of “a,” “an,” or “the,” is intended to mean “at least one,” unless specifically indicated to the contrary.

What is claimed is:

1. A method comprising:
receiving, by a server computer, a transaction request for a cryptocurrency transaction from a user associated with a user device to a resource provider associated with a resource provider computer, the transaction request comprising an indication of a cryptocurrency wallet associated with the user and a transaction amount, wherein the cryptocurrency wallet comprises a funding source;
communicating, by the server computer, with a cryptocurrency exchange computer associated with the cryptocurrency wallet to determine that a balance of the funding source is greater than or equal to the transaction amount;
providing, by the server computer to the user device, transaction details including the funding source, the transaction amount, and the balance of the funding source in the cryptocurrency wallet;
receiving, by the server computer, confirmation of the cryptocurrency transaction from the user device;
transmitting, by the server computer, an instruction to the cryptocurrency exchange computer to place a hold on the funding source for the transaction amount;
providing, by the server computer, an authorization message to the resource provider computer indicating authorization of the cryptocurrency transaction;
receiving, by the server computer from the resource provider computer, an acceptance message; and
providing, by the server computer to the cryptocurrency exchange computer, the acceptance message, wherein a transfer of cryptocurrency funds in the transaction amount from the funding source to an account of the resource provider associated with the resource provider computer thereafter occurs.

2. The method of claim 1, wherein the resource provider computer communicates with the server computer via a gateway computer.

3. The method of claim 1, wherein the server computer comprises a settlement wallet module, and a plurality of gateway escrow modules for a plurality of resource provider gateways in communication with a plurality of resource provider computers, and a plurality of exchange sub-wallets associated with a plurality of cryptocurrency exchanges, each cryptocurrency exchange associated with a plurality of users.

4. The method of claim 3, wherein funds are moved from an exchange sub-wallet of the plurality of exchange sub-wallets to the settlement wallet module at predetermined intervals.

5. The method of claim 3, wherein funds are added to each exchange sub-wallet of the plurality of exchange sub-wallets from each respective cryptocurrency exchange of the plurality of cryptocurrency exchanges when a balance of each exchange sub-wallet falls below a predetermined threshold.

6. The method of claim 3, wherein funds are added to a gateway escrow module of the plurality of gateway escrow modules from a respective resource provider gateway of the plurality of resource provider gateways when a balance of the gateway escrow module falls below a predetermined threshold.

7. The method of claim 3, further comprising:
identifying, by the server computer, an exchange sub-wallet of the plurality of exchange sub-wallets associated with the cryptocurrency exchange computer; and
determining, by the server computer, whether an available balance of the exchange sub-wallet is greater than or equal to the transaction amount, wherein the available balance is an actual balance of the exchange sub-wallet minus a settlement position.

8. A server computer comprising:
a processor; and
a computer readable medium, the computer readable medium comprising code, executable by the processor, for implementing a method comprising:
receiving a transaction request for a cryptocurrency transaction from a user associated with a user device to a resource provider associated with a resource provider computer, the transaction request comprising an indication of a cryptocurrency wallet associated with the user and a transaction amount, wherein the cryptocurrency wallet comprises a funding source;
communicating with a cryptocurrency exchange computer associated with the cryptocurrency wallet to determine that a balance of the funding source is greater than or equal to the transaction amount;
providing, to the user device, transaction details including the funding source, the transaction amount, and the balance of the funding source in the cryptocurrency wallet;
receiving confirmation of the cryptocurrency transaction from the user device;
transmitting an instruction to the cryptocurrency exchange computer to place a hold on the funding source for the transaction amount;
providing an authorization message to the resource provider computer indicating authorization of the cryptocurrency transaction;
receiving, from the resource provider computer, an acceptance message; and
providing, to the cryptocurrency exchange computer, the acceptance message, wherein a transfer of cryptocurrency funds in the transaction amount from the funding source to an account of the resource provider associated with the resource provider computer thereafter occurs.

9. The server computer of claim 8, wherein the method further comprises:
receiving authentication information associated with the user;
authenticating the user based on the authentication information;
retrieving a set of cryptocurrency wallets associated with the user; and
receiving a selection of the cryptocurrency wallet from the set of cryptocurrency wallets for use in completing the cryptocurrency transaction.

10. The server computer of claim 9, wherein the method further comprises:
determining that the balance of the funding source in the cryptocurrency wallet is less than the transaction amount; and
transmitting, to the user device, instructions causing the user device to prompt the user to select another cryptocurrency wallet from the set of cryptocurrency wallets with which to complete the cryptocurrency transaction.

11. The server computer of claim 8, wherein the method further comprises:
receiving, from the cryptocurrency exchange computer, a registration request associated with a user of the user device, wherein the registration request is associated with a request to link the cryptocurrency wallet of the user with the server computer;
authenticating, via the user device, the user, wherein authenticating the user comprises receiving a one-time password from the user device; and
creating a user account associated with the user and the linked cryptocurrency wallet, wherein the linked cryptocurrency wallet is associated with the user and stored in a database.

12. The server computer of claim 8, wherein the resource provider computer communicates with the server computer via a gateway computer.

13. The server computer of claim 8, further comprising a settlement wallet module, and a plurality of gateway escrow modules for a plurality of resource provider gateways in communication with a plurality of resource provider computers, and a plurality of exchange sub-wallets associated with a plurality of cryptocurrency exchanges, each cryptocurrency exchange associated with a plurality of users.

14. The server computer of claim 13, wherein the method further comprises:
transferring funds from an exchange sub-wallet of the plurality of sub-wallets to the settlement wallet module at predetermined intervals.

15. A method comprising:
receiving, by a server computer, a predetermined amount of funds from a cryptocurrency exchange computer, wherein the predetermined amount of funds is stored in an exchange sub-wallet of the server computer that is associated with the cryptocurrency exchange computer;
receiving, by a server computer, transaction information associated with a transaction between a user and a resource provider, wherein the transaction comprises a transaction amount and is associated with a cryptocurrency exchange computer; and
at a first predetermined interval, transferring, by the server computer, funds in the transaction amount from the exchange sub-wallet to a settlement wallet of the server computer.

16. The method of claim 15, further comprising:
determining, by the server computer, that a balance of the exchange sub-wallet is below a predetermined threshold; and
transmitting, by the server computer to the cryptocurrency exchange computer, a notification indicating that the balance is below the predetermined threshold.

17. The method of claim 15, wherein the server computer comprises a plurality of gateway escrow modules for a plurality of gateway computers in communication with a plurality of resource provider computers.

18. The method of claim 17, further comprising:
at a second predetermined interval, transferring an escrow amount to a gateway escrow module of the plurality of gateway escrow modules from a resource provider gateway wallet.

19. The method of claim 17, further comprising:
receiving, by the server computer from the cryptocurrency exchange computer, a refund request for a refund from a resource provider to a user, the refund request comprising an indication of a cryptocurrency wallet associated with the user and a refund amount;
transferring, by the server computer, the refund amount from a gateway escrow module associated with the resource provider to the settlement wallet;
transferring, by the server computer, the refund amount from the settlement wallet to the exchange sub-wallet; and
providing, to the cryptocurrency exchange computer, a refund message, wherein a transfer of cryptocurrency funds in the refund amount from a resource provider wallet to a cryptocurrency wallet of the user thereafter occurs.

20. The method of claim 19, further comprising:
determining, by the server computer a net settlement position with the exchange sub-wallet based on an accumulated transaction amount less an accumulated refund amount.
